(19) United States
(12) Patent Application Publication
(10) Pub. No.: US 2016/0218437 A1
(43) Pub. Date: Jul. 28, 2016

(54) DIELECTRIC RESONATOR ANTENNA ARRAYS

(71) Applicants: Ajay Babu GUNTUPALLI, Montreal (CA); Ke WU, Montreal (CA); Tarek DJERAFI, Montreal (CA)

(72) Inventors: Ajay Babu GUNTUPALLI, Montreal (CA); Ke WU, Montreal (CA); Tarek DJERAFI, Montreal (CA)

(21) Appl. No.: 14/606,715

(22) Filed: Jan. 27, 2015

(51) Int. Cl. H01Q 19/06; H01Q 15/08

(52) U.S. Cl. CPC H01Q 19/062; H01Q 15/08

(57) ABSTRACT

A dielectric resonator antenna (DRA) array having an array feeding network and a parasitic patch array made up of individual antenna elements is provided with a dielectric lens made from a single piece of dielectric material in the form of a generally planar sheet. The sheet may be substantially coextensive with the DRA array so as to cover all of the antenna elements. The single piece of dielectric material has a plurality of dielectric portions defined by a plurality of holes through the sheet. Each dielectric portion may be positioned over one of the antenna elements. Adjacent dielectric portions are connected to each other along connecting edge portions thereof, and a single hole is defined through the sheet between connecting edge portions of a group of mutually adjacent dielectric portions.

### FIELD

The present disclosure relates generally to a design for a lens element, and in a particular embodiment, to a dielectric lens element for a dielectric resonator antenna (DRA) arrays.

### BACKGROUND

Millimeter-wave frequency bands utilizing frequencies around 60 GHz can be employed to realize the next-generation wireless short-haul high-speed microwave communication links between wireless devices. Millimeter-wave antenna arrays needs to satisfy the link budget requirement. The path loss can be compensated by using high gain antenna arrays for transmitting and receiving electromagnetic signals. The antenna elements such arrays should initially achieve acceptable gain. Various methods have been proposed to increase antenna element gain, including the use of a dielectric resonating element attached on each antenna element. Examples of some dielectric resonator antenna (DRA) arrays according to the prior art are disclosed in Petosa, A.; Ittipiboon, A. “Dielectric Resonator Antennas: A Historical Review and the Current State of the Art”, Antennas and Propagation Magazine, IEEE, pages 91-116, Volume: 52, Issue: 5, October 2010.

### SUMMARY

In one aspect, the present disclosure provides a dielectric lens for a dielectric resonator antenna (DRA) array having a plurality of antenna elements. The dielectric lens comprises a single piece of dielectric material in the form of a generally planar sheet. The sheet is substantially coextensive with the DRA array so as to cover all of antenna elements. The single piece of dielectric material comprises a plurality of dielectric portions defined by a plurality of holes through the sheet. Each dielectric portion is positioned over one of the antenna elements. Adjacent dielectric portions are connected to each other along connecting edge portions thereof. A single hole is defined through the sheet between connecting edge portions of a group of mutually adjacent dielectric portions.

In another aspect, the present disclosure provides a dielectric resonator antenna (DRA) array having an array feeding network, a parasitic patch array with a plurality of antenna elements, and a dielectric lens made from a single piece of dielectric material in the form of a generally planar sheet. The sheet is substantially coextensive with the DRA array so as to cover all of the plurality of antenna elements. The single piece of dielectric material comprises a plurality of dielectric portions defined by a plurality of holes through the sheet. Each dielectric portion is positioned over one of the antenna elements. Adjacent dielectric portions are connected to each other along connecting edge portions thereof. A single hole is defined through the sheet between connecting edge portions of a group of mutually adjacent dielectric portions.

The plurality of antenna elements and the plurality of dielectric portions may be arranged in rectangular arrays, with each rectangular array forming a grid of generally perpendicular rows and columns. The plurality of antenna elements may be arranged in a plurality of 2×2 sub arrays, and the plurality of dielectric elements may be arranged in a plurality of sub groups corresponding to the plurality of 2×2 sub arrays.

The holes may comprise a plurality of first holes, a plurality of second holes larger than the first holes, and a plurality of third holes larger than the second holes. Each first hole may be positioned between four dielectric elements of a single sub group, each second hole may be positioned between four dielectric elements from two different sub groups, and each third hole may be positioned between four dielectric elements from four different sub groups.

In another aspect, the present disclosure provides a method for producing a dielectric lens for a dielectric resonator antenna (DRA) array. The method comprises providing a single piece of dielectric material in the form of a generally planar sheet, the sheet being substantially coextensive with the DRA array so as to cover all of the plurality of antenna elements, determining locations for a plurality of holes through the sheet based on locations of the plurality of antenna elements, and forming the plurality of holes through the sheet to define a plurality of dielectric portions, each dielectric portion being configured to be positioned over one of the plurality of antenna elements.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is an exploded perspective view an example dielectric resonator antenna (DRA) array according to one embodiment

FIG. 2 is a perspective view of the dielectric sheet of the example DRA array of FIG. 1.

FIG. 3 is a perspective view of an example prior art array of individual dielectric elements.

FIG. 4 is a top plan view of the dielectric sheet of the example DRA array of FIG. 1.

FIG. 5 is a perspective view of an example dielectric sheet for a 2×2 sub array of the example DRA array of FIG. 1.

FIG. 6 is a flowchart illustrating steps of an example method of forming a dielectric sheet for a DRA array according to one embodiment.

FIG. 7 is a top plan view of an example dielectric sheet for a DRA array according to another embodiment.

FIG. 8 is a top plan view of an example dielectric sheet for a DRA array according to another embodiment.

FIG. 9 is a top plan view of an example dielectric sheet for a DRA array according to another embodiment.

FIG. 10 is a top plan view of an example dielectric sheet for a DRA array according to another embodiment.

### DETAILED DESCRIPTION

Generally, the present disclosure is directed to a dielectric lens for use in a dielectric resonator array. In some disclosed embodiments, the lens is in the form of a single dielectric sheet of dielectric material for a dielectric resonator antenna (DRA) array. The sheet has a plurality of dielectric elements defined by a plurality of holes through the sheet.

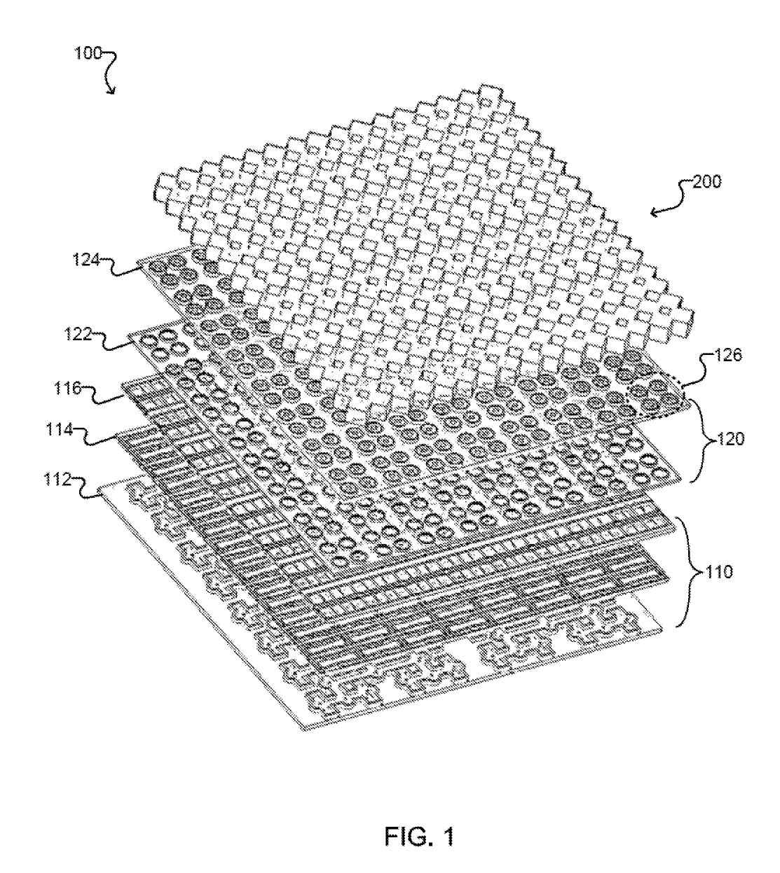

FIG. 1 shows an example of a DRA array 100 according to one embodiment. The DRA array comprises an array feeding network 110, a parasitic patch array 120, and a dielectric lens in the form of a single dielectric sheet 200, which is described in further detail below. In the illustrated example, the array feeding network 110 comprises three layers 112, 114, 116 configured to provide signals to and receive signals from the parasitic patch array 120. The parasitic patch array 120 comprises first and second layers 122, 124, each comprising a plurality of antenna elements (not enumerated). In the illustrated example, the antenna elements of the parasitic patch array 120 are arranged into a plurality of sub arrays 126 of four individual antenna elements in a 2×2 rectangular grid, and the spacing between adjacent antenna elements within each sub array 126 is smaller than the spacing between adjacent antenna elements from different sub arrays 126. In some embodiments, the DRA array is configured to operate in a frequency bandwidth of about 57-66 GHz.

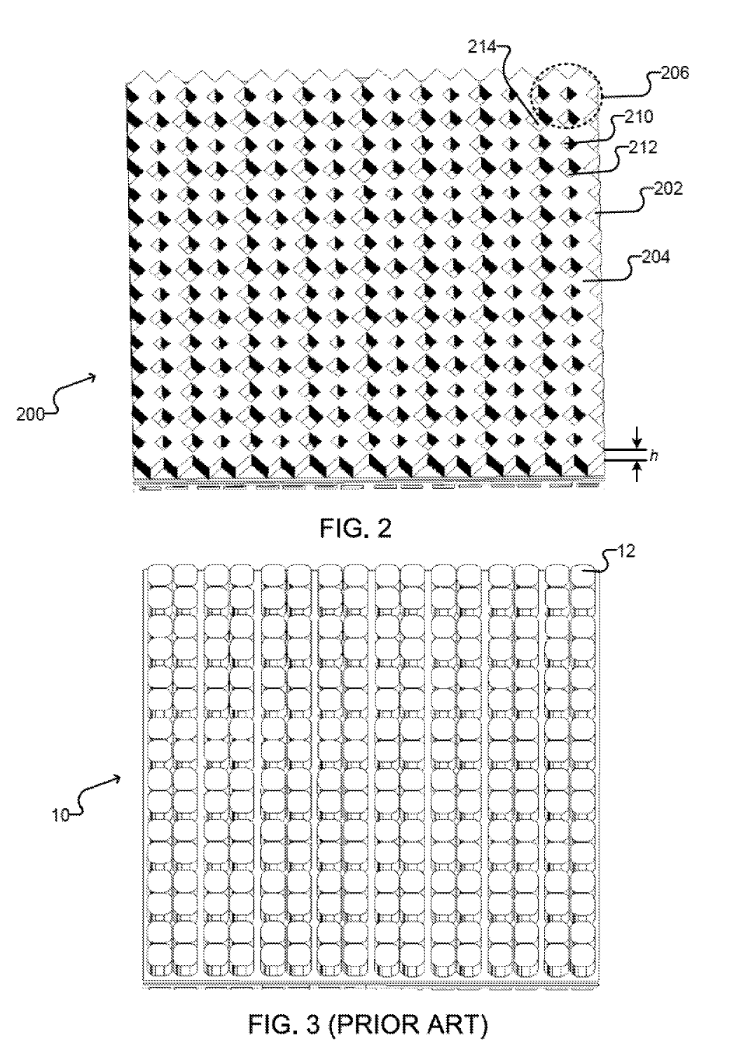

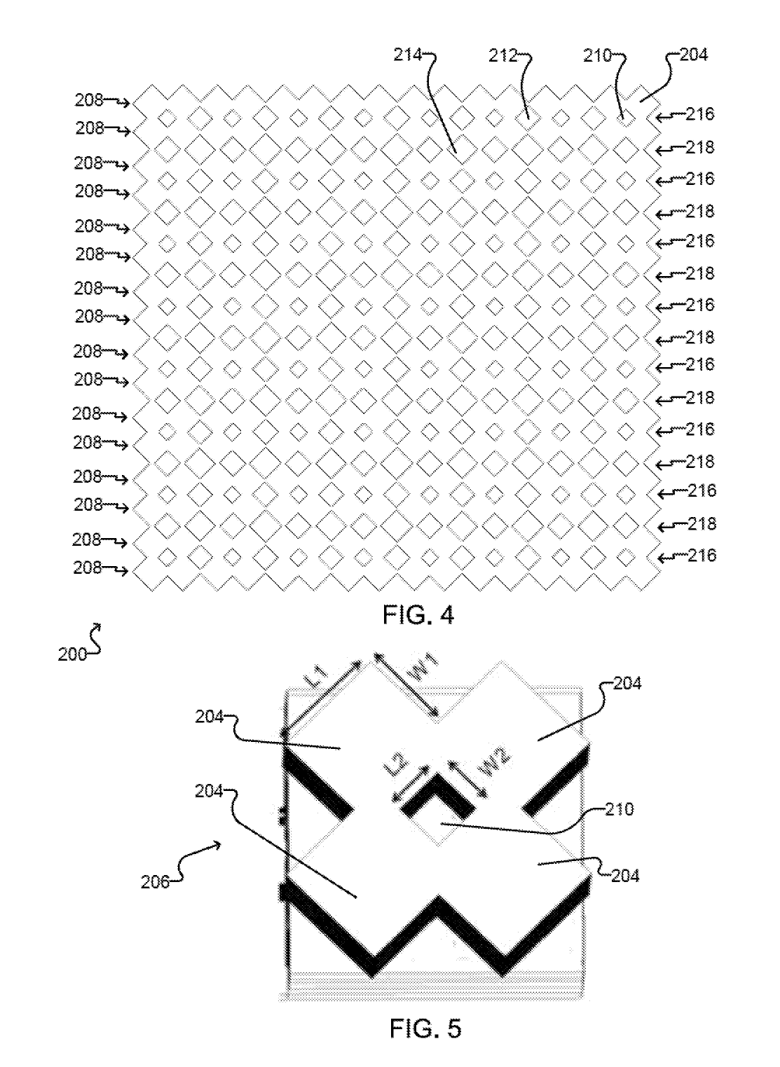

As shown in FIGS. 2 and 4, the sheet 200 of FIG. 1 comprises a single piece 202 of dielectric material that is generally planar and has a substantially uniform height h (also referred to as a thickness). In some embodiments, the piece of dielectric material has a height h that is selected based on a signal wavelength A of the DRA array 100. In some embodiments, the piece of dielectric material has a height h in the range of 0.5λ to 0.6λ. In some embodiments, the piece of dielectric material has a height h in the range of 100-120 mils. In some embodiments, the dielectric material has a dielectric constant in the range of 2 to 10, depending on the dielectric constant of the array feeding network 110.

The single piece 202 of dielectric material comprises a plurality of dielectric portions 204 defined by a plurality of holes 210, 212, 214 through the sheet 200. Each dielectric portion 204 is configured to be positioned over one of the antenna elements of the parasitic patch array 120. By way of contrast, FIG. 3 shows an example prior art array 10 of individual dielectric elements 12. Each dielectric element 12 must be individually positioned and mounted atop a corresponding antenna element. The sheet 200 of FIG. 2 advantageously eliminates the need for individual alignment of dielectric elements, since only the single piece 202 needs to be aligned with the parasitic patch array 120.

The dielectric portions 204 are each connected to adjacent dielectric portions 204 by connecting edge portions. In the illustrated example, the dielectric portions 204 are generally rhombus-shaped (e.g. squares), with the connecting edge portions comprising corner portions of each square. A single hole 210/212/214 is defined between connecting edge portions of a group of mutually adjacent dielectric portions 204. The term “mutually adjacent dielectric portions” is used herein to refer to a group of dielectric portions 204 that are all either horizontally, vertically or diagonally (with reference to the orientation illustrated in FIGS. 2 and 4) adjacent to one another, and which surround a single hole 210/212/214. In some embodiments, such as for example embodiments wherein the underlying antenna elements are all evenly spaced, all of the holes may be the same size. In other embodiments, such as for example the embodiment shown in FIGS. 2 and 4, the holes 210/212/214 may have different sizes, as discussed below.

In the illustrated example, the dielectric portions 204 are arranged in sub groups 206, with each sub group 206 configured to be positioned over a corresponding sub array 126 of the parasitic patch array 120. The connecting edge portions between adjacent dielectric portions 204 within a sub group 206 are more extensive than the connecting edge portions between adjacent dielectric portions 204 from adjacent sub groups 206, due to the difference in spacing between the underlying antenna elements. As a consequence, in the illustrated example, each of the holes 210 within a sub group 206 is smaller than each of the holes 212 between horizontally or vertically (with reference to the orientation illustrated in

FIGS. 2 and 4) adjacent sub groups 206. Similarly, each of the holes 212 between horizontally or vertically (with reference to the orientation illustrated in FIGS. 2 and 4) adjacent sub groups 206 is smaller than each of the holes 214 between diagonally (with reference to the orientation illustrated in FIGS. 2 and 4) adjacent sub groups 206.

With reference to FIG. 4, in the illustrated embodiment the dielectric portions 204 are arranged in a rectangular array comprising a grid of generally perpendicular rows 208 and columns (not enumerated). The holes 210, 212, 214 are also arranged in a complementary grid, with alternating types of rows 216/218 and columns (not enumerated). The rows 216 that pass through sub groups 206 comprise alternating ones of holes 210 and 212, and the rows 218 that pass between adjacent sub groups 216 comprise alternating ones of holes 212 and 214.

FIG. 5 shows an example sub group 216 in isolation. Each dielectric portion 204 of the sub group 206 is generally square-shaped, with each of the sides of the square having a length L1. The corner portions of each dielectric portion 204 overlap with the horizontally and vertically adjacent dielectric portions 204 to form connecting edge portions.

The distance from the outer side of one dielectric portion 204 to the location at which the corner portion overlaps with an adjacent dielectric portion 204 is W1, which is less than L1. The hole 210 in the center of the sub group has sides of length L2 and W2. In some embodiments the hold 210 is square and L2=W2.

Experimental results obtained with a single dielectric sheet comprising an array of 16×16 dielectric portions similar to the examples illustrated in FIGS. 2 and 4 indicate a peak gain of 3 dB with a bandwidth of 14.7% at 61 GHz. With reference to the dimensions shown in FIG. 5, in the experimental embodiment, L1=3.6 mm; W1=2.89 mm and L2=W2=1.58 mm. In the experimental embodiment, the sheet had a height h of 120 mils and the material had a dielectric constant of 2.94. The effective dielectric constant is reduced once the holes 210/212/214 are formed.

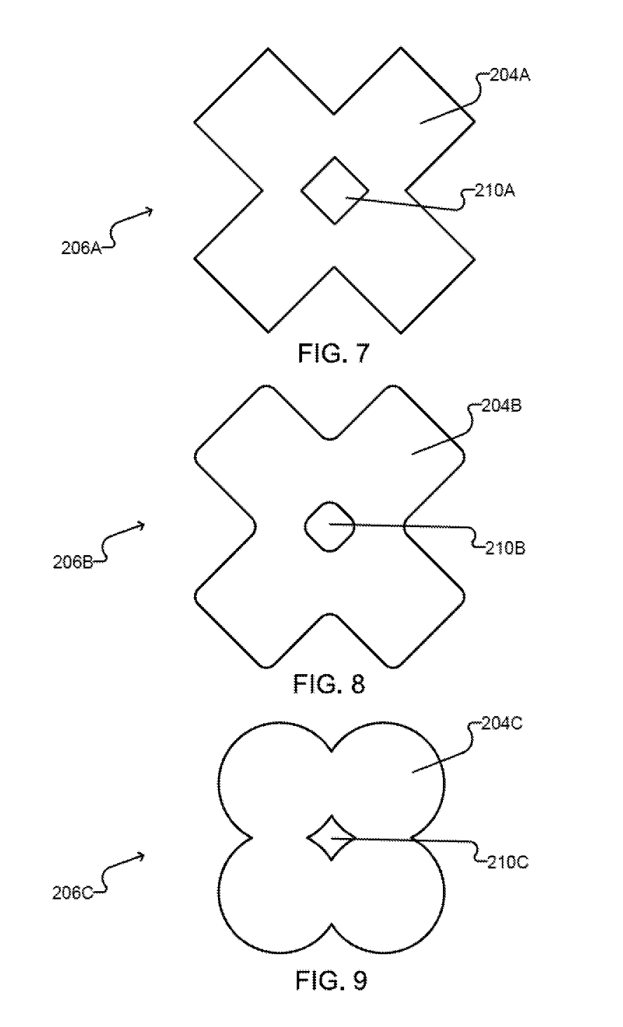

The examples discussed above contemplate generally square-shaped dielectric portions 204 and holes 210/212/214. However, it is to be understood that different sizes and shapes of the dielectric portions and holes may be utilized in other embodiments. Some examples of differently shaped dielectric portions and holes are discussed below with reference to FIGS. 7-10.

The sizes of the holes 210/212/214 may be selected based on the sizes of the dielectric portions. In some embodiments, each hole is has a minimum dimension of at least one half of the minimum dimension of the dielectric portions. In some embodiments, each hole through the sheet of dielectric material has a minimum dimension in the range of 0.5-2 mm. The term “minimum dimension”, as used herein means the shortest distance from one side of the dielectric portion or hole, through the center of the dielectric portion or hole, to an opposed side of the dielectric portion or hole. For example, for a square hole, the minimum dimension is the length of one of the sides of the square. For a rectangular hole, the minimum dimension is the length of one of the shorter sides of the rectangle. For a circular hole, the minimum dimension is the diameter of the circle. As discussed above and illustrated in the Figures, holes 210/212/214 can have different sizes. Holes 210/212/214 can also have different shapes.

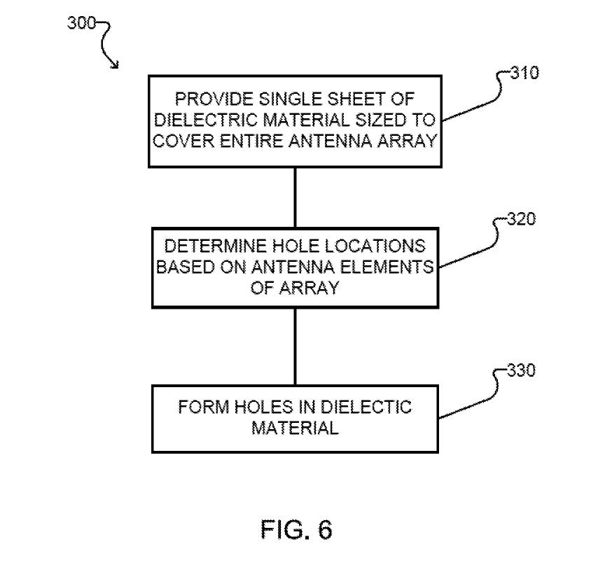

FIG. 6 is a flowchart illustrating steps of an example method 300 for producing a dielectric lens for a DRA array according to one embodiment. At 310 a single piece of dielectric material in the form of a generally planar sheet is provided. The sheet may be substantially coextensive with the DRA array such that the sheet is large enough to cover all of the plurality of antenna elements.

At 320 locations for a plurality of holes through the sheet of dielectric material are determined. The locations may be determined based on locations of the plurality of antenna elements of the DRA array. For each determined hole location, a hole size and hole shape may also be determined. As noted above, in some embodiments the holes may all have the same size, and in other embodiments the holes may have different sizes, depending on whether or not the antenna element are regularly spaced or arranged into sub arrays.

At 330 the holes are formed through the sheet of dielectric material. In some embodiments, forming the holes may comprise drilling through the sheet of dielectric material with a high-powered laser. Depending on the type of laser used and the thickness of the sheet, the high-powered laser may make multiple passes to drill a single hole through the sheet of dielectric material. In some embodiments, forming the holes may comprise cutting through the sheet of dielectric material with a water jet cutter. The edges of the sheet may also be shaped to conform to the pattern of holes and dielectric portions, either when the sheet is provided or when the holes are formed. In some embodiments, forming the sheet and holes may comprise defining a mask based on determined locations, sizes and shapes for the holes, and forming the sheet using a 3D printing technique.

FIG. 7 shows an example 2×2 sub group 206A of a dielectric lens according another embodiment. In the FIG. 7 embodiment, each dielectric portion 204A is generally rectangle-shaped, and the hole 210A within the sub group 206A is generally square-shaped. FIG. 8 shows an example 2×2 sub group 206B of a dielectric lens according another embodiment. In the FIG. 8 embodiment, each dielectric portion 204B is generally rounded-rectangle-shaped (i.e., a rectangle with rounded corners), and the hole 210B within the sub group 206B is generally rounded-square-shaped. FIG. 9 shows an example 2×2 sub group 206C of a dielectric lens according another embodiment. In the FIG. 9 embodiment, each dielectric portion 204C is generally circle-shaped, and the hole 210C within the sub group 206C is generally pseudo-square-shaped with inwardly arced sides. Other shapes are also possible for the dielectric portions. As discussed above and illustrated in the Figures, holes 2101A-C/212A-C/214A-C can have different sizes. Holes 210A-C/212A-C/214A-C can also have different shapes.

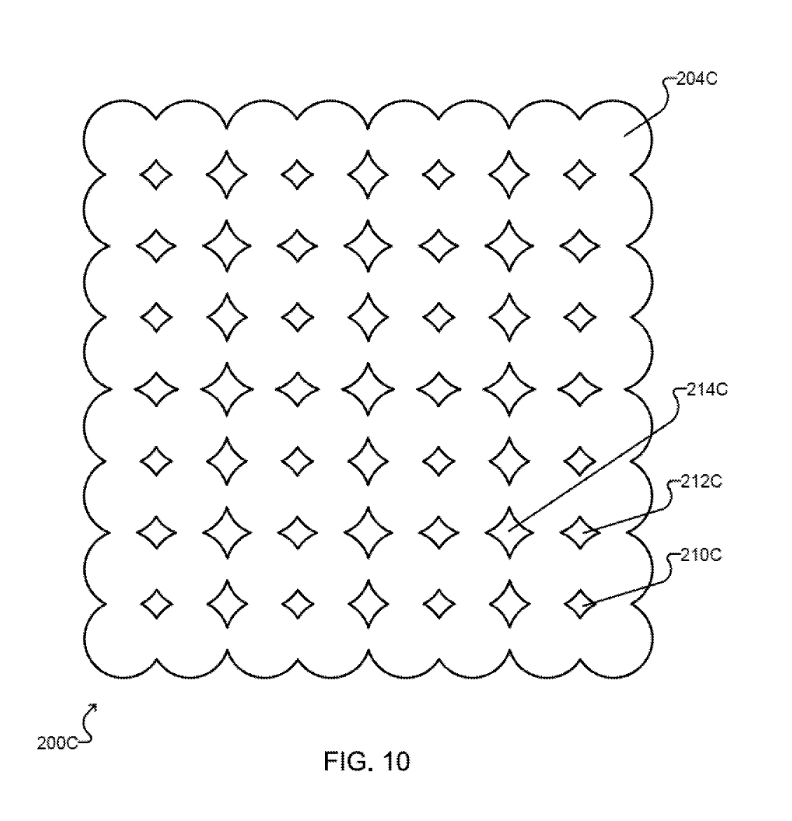

Any of the sub groups 206A-C shown in FIGS. 7-9 may be used to form larger a dielectric lens. For example, FIG. 10 shows a dielectric lens in the form of a single dielectric sheet 200C, comprising an 8×8 array of circular dielectric portions 204C arranged in sub groups of the type shown in FIG. 9. Similar to the embodiment of FIGS. 2 and 4, each of the holes 210C within a sub group 206C is smaller than each of the holes 212C between horizontally or vertically (with reference to the orientation illustrated in FIG. 10) adjacent sub groups 206C. Similarly, each of the holes 212C between horizontally or vertically (with reference to the orientation illustrated in FIG. 10) adjacent sub groups 206C is smaller than each of the holes 214C between diagonally (with reference to the orientation illustrated in FIG. 10) adjacent sub groups 206C.

In the examples discussed above, a dielectric lens is provided in the form of a single sheet sized to cover all of the antenna elements of a DRA array. In other embodiments, more than one dielectric sheet may be used to cover the DRA array, for example by providing a dielectric lens in the form two sheets, with one sheet sized to cover a first plurality of antenna elements and the other sheet sized to cover a second plurality of antenna elements. As one skilled in the art will appreciate, more than two sheets may also be provided in some embodiments.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown schematically in order not to obscure the understanding. For example, specific details are not provided as to the particular construction and mode of operation of the array feeding network 110 and the parasitic patch array 120.

The above-described embodiments are intended to be examples only.

Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A dielectric lens comprising:
a single piece of dielectric material in the form of a generally planar sheet, the sheet being sized to cover a plurality of dielectric resonator antenna elements;
wherein the single piece of dielectric material comprises a plurality of dielectric portions defined by a plurality of holes through the sheet, each dielectric portion being configured to be positioned over one of the plurality of antenna elements,
and wherein adjacent dielectric portions are connected to each other along connecting edge portions thereof, and a single hole is defined through the sheet between connecting edge portions of a group of mutually adjacent dielectric portions.

2. The dielectric lens of claim 1 wherein the plurality of dielectric portions are arranged in a rectangular array comprising a grid of generally perpendicular rows and columns.

3. The dielectric lens of claim 2 wherein the single hole is defined between each group of four dielectric portions.

4. The dielectric lens of claim 3 wherein each dielectric portion is generally rhombus-shaped.

5. The dielectric lens of claim 1 wherein each dielectric portion is generally square-shaped and each of the single holes is generally square-shaped, with sides of each hole oriented at an angle of about 45 degrees to the rows and columns of the grid.

6. The dielectric lens of claim 5 wherein the sides of each of the single holes has a length in the range of about 0.5-2 mm.

7. The dielectric lens of claim 1 wherein each dielectric portion is generally rhombus-shaped.

8. The dielectric lens of claim 1 wherein each dielectric portion is generally square-shaped.

9. The dielectric lens of claim 1 wherein each dielectric portion is generally rectangle-shaped.

10. The dielectric lens of claim 1 wherein each dielectric portion is generally circle-shaped.

11. The dielectric lens of claim 1 wherein each hole has a minimum dimension in the range of 0.5-2 mm.

12. The dielectric lens of claim 1 wherein the sheet has a thickness in the range of about 0.5λ to 0.6λ, where λ is a signal wavelength of the DRA array.

13. The dielectric lens of claim 1 where the dielectric material has a dielectric constant in the range of about 2-10.

14. A dielectric resonator antenna (DRA) array comprising:
an array feeding network;
a parasitic patch array comprising a plurality of antenna elements; and
a dielectric lens comprising:
a single piece of dielectric material in the form of a generally planar sheet, the sheet being of a substantially similar size to the DRA array so as to cover all of the plurality of antenna elements;
wherein the single piece of dielectric material comprises a plurality of dielectric portions defined by a plurality of holes through the sheet, each dielectric portion being configured to be positioned over one of the plurality of antenna elements,
and wherein adjacent dielectric portions are connected to each other along connecting edge portions thereof, and a single hole is defined through the sheet between connecting edge portions of a group of mutually adjacent dielectric portions.

15. The DRA array of claim 14 wherein the plurality of antenna elements and the plurality of dielectric portions are arranged in rectangular arrays, each rectangular array comprising a grid of generally perpendicular rows and columns.

16. The DRA array of claim 15 wherein the plurality of antenna elements are arranged in a plurality of 2×2 sub arrays, and wherein the plurality of dielectric elements are arranged in a plurality of sub groups corresponding to the plurality of 2×2 sub arrays.

17. The DRA array of claim 16 wherein the plurality of holes comprise a plurality of first holes, a plurality of second holes larger than the first holes, and a plurality of third holes larger than the second holes, wherein each first hole is positioned between four dielectric elements of a single sub group, each second hole is positioned between four dielectric elements from two different sub groups, and each third hole is positioned between four dielectric elements from four different sub groups.

18. A method for producing a dielectric lens for a dielectric resonator antenna (DRA) array, the method comprising:
providing a single piece of dielectric material in the form of a generally planar sheet, the sheet being of a substantially similar size to the DRA array so as to cover all of the plurality of antenna elements;
determining locations for a plurality of holes through the sheet based on locations of the plurality of antenna elements; and
forming the plurality of holes through the sheet to define a plurality of dielectric portions, each dielectric portion being configured to be positioned over one of the plurality of antenna elements.

19. The method of claim 18 wherein forming the plurality of holes comprises drilling through the single piece of dielectric material with a laser.

20. The method of claim 18 wherein forming the plurality of holes comprises cutting through the single piece of dielectric material with a water jet.
